(19) United States
(12) Patent Application Publication
(10) Pub. No.: US 2025/0366669 A1
(43) Pub. Date: Dec. 4, 2025

(54) STAND MIXER APPLIANCE POWER TAKE OFF ATTACHMENT AUTOMATIC OPERATION

(71) Applicant: Haier US Appliance Solutions, Inc., Wilmington, DE (US)

(72) Inventor: Tomas Garces, Louisville, KY (US)

(21) Appl. No.: 18/733,390

(22) Filed: Jun. 4, 2024

(51) Int. Cl. A47J 43/08; A47J 43/044

(52) U.S. Cl. CPC A47J 43/082; A47J 43/044; A47J 2043/0449

(57) ABSTRACT

A method of operating the stand mixer includes the controller receiving an input indicative of a food processing operation. The method also includes measuring an initial value of the parameter of the food contents and recording the initial value of the parameter of the food contents in a memory in communication with the controller. The method also includes operating the motor to process the food contents through the power take off attachment, monitoring a current value of the parameter of the food contents, and determining a mathematical difference between the current value and the initial value of the parameter of the food contents. The method further includes pausing the motor of the stand mixer in response to determining the mathematical difference between the monitored value of the parameter and the initial value of the parameter is equal to a desired value of the parameter.

### FIELD OF THE INVENTION

The present subject matter relates generally to methods of operating stand mixers, and more particularly to methods of automatic operation of power take off attachment of stand mixer appliances.

### BACKGROUND OF THE INVENTION

Stand mixers are traditionally used for performing mixing, churning, or kneading operations involved in food preparation. Typically, stand mixers include a motor configured to provide torque to one or more driveshafts. Users may connect various utensils to the one or more driveshafts, including whisks, spatulas, or power take off attachments. Operating a stand mixer is frequently a manual process, which involves the user actively monitoring the mixing process. Thus, during the mixing process, a user is positioned close to the mixer in order to monitor the contents and to turn-off the stand mixer when the contents are processed as desired. In certain mixing processes, such as processing grain, the mixing process can become undesirable as the process may be time-consuming. For a user, actively monitoring the stand mixer during the mixing process can be tedious and inconvenient.

Accordingly, a stand mixer configured to automatically operate mixing process of power take off attachments would be advantageous.

### BRIEF DESCRIPTION OF THE INVENTION

Aspects and advantages of the invention will be set forth in part in the following description, or may be apparent from the description, or may be learned through practice of the invention.

In one example embodiment, a method of operating a stand mixer is provided. The stand mixer includes a housing, a motor disposed in the housing, a scale, a power take off extending from the housing, a power take off attachment mechanically coupled to the power take off, and a controller disposed in the housing. The controller is in operable communication with the scale and the motor. The method includes the controller receiving an input indicative of a food processing operation. The food processing operation defines a desired value of a parameter of food contents. The method also includes the scale measuring an initial value of the parameter of the food contents within the power take off attachment, and the controller recording the initial value of the parameter of the food contents in a memory in communication with the controller. The method also includes operating the motor to process the food contents through the power take off attachment, monitoring a current value of the parameter of the food contents, and determining a mathematical difference between the current value of the parameter of the food contents and the initial value of the parameter of the food contents. The method further includes pausing the motor of the stand mixer in response to determining the mathematical difference between the monitored value of the parameter and the initial value of the parameter is equal to the desired value of the parameter.

In another example embodiment, a stand mixer is provided. The stand mixer includes a housing, a motor disposed in the housing, a scale, a power take off extending from the housing, a power take off attachment mechanically coupled to the power take off, and a controller disposed in the housing. The controller is in operable communication with the scale and the motor. The controller is configured to receive an input indicative of a food processing operation. The food processing operation defines a desired value of a parameter of food contents. The controller is also configured to measure an initial value of the parameter of the food contents within the power take off attachment and record the initial value of the parameter of the food contents in a memory in communication with the controller. The controller is also configured to operate the motor to process the food contents through the power take off attachment, monitor a current value of the parameter of the food contents, and determine a mathematical difference between the current value of the parameter of the food contents and the initial value of the parameter of the food contents. The controller is further configured to pause the motor of the stand mixer in response to determining the mathematical difference between the monitored value of the parameter and the initial value of the parameter is equal to the desired value of the parameter.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side elevation view of a stand mixer according to an example embodiment of the present disclosure.

FIG. 2 provides a front view of a stand mixer according to an example embodiment of the present disclosure.

FIG. 3 illustrates a flow diagram of an example method of operating a stand mixer according to aspects of the present disclosure.

FIG. 4 illustrates an example network according to aspects of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

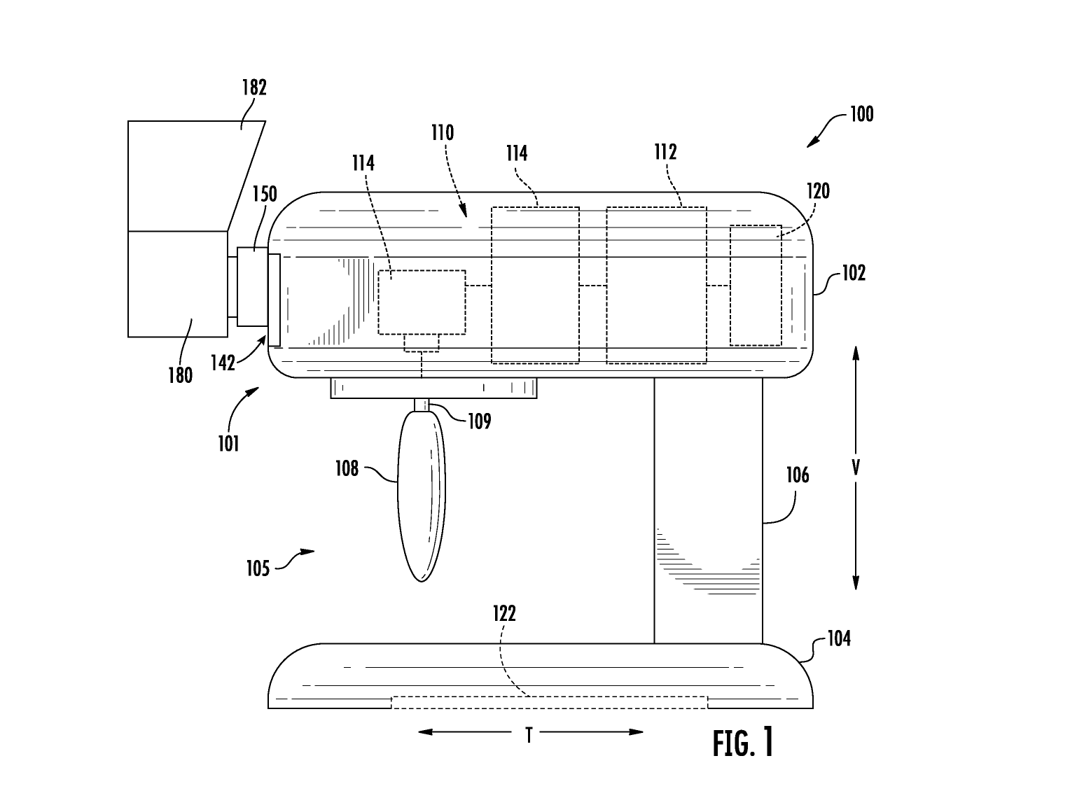

FIG. 1 provides a side, elevation view of a stand mixer 100 according to an example embodiment of the present subject matter. It will be understood that stand mixer 100 is provided by way of example only and that the present subject matter may be used in or with any suitable stand mixer in alternative example embodiments. Moreover, stand mixer 100 of FIG. 1 defines a vertical direction V and a transverse direction T, which are perpendicular to each other. It should be understood that these directions are presented for example purposes only, and that relative positions and locations of certain aspects of stand mixer 100 may vary according to specific embodiments, spatial placement, or the like.

Stand mixer 100 may include a casing 101. In detail, casing 101 may include a motor housing 102, a base 104, and a column 106. Motor housing 102 may house various mechanical and/or electrical components of stand mixer 100, which will be described in further detail below. For example, as shown in FIG. 1, a motor 112, a planetary or reduction gearbox 114, and a bevel gearbox 116 may be disposed within motor housing 102. Base 104 may support motor housing 102. For example, motor housing 102 may be mounted (e.g., pivotally) to base 104 via column 106, e.g., that extends upwardly (e.g., along the vertical direction V) from base 104. Motor housing 102 may be suspended over a mixing zone 105, within which a mixing bowl may be disposed and/or mounted to base 104.

A drivetrain 110 may be provided within motor housing 102 and configured for coupling motor 112 to a shaft 109 (e.g., a mixer shaft) or a power take off 150. Drivetrain 110 may include planetary gearbox 114, bevel gearbox 116, etc. Mixer shaft 109 may be positioned above mixing zone 105 on motor housing 102, and an attachment 108, such as a beater, whisk, or hook, may be removably mounted to mixer shaft 109. Attachment 108 may rotate within a bowl (not shown) in mixing zone 105 to beat, whisk, knead, etc. material within the bowl during operation of motor 112.

As noted above, motor 112 may be operable to rotate mixer shaft 109. Motor 112 may be a direct current (DC) motor in certain example embodiments. In alternative example embodiments, motor 112 may be an alternating current (AC) motor. Motor 112 may include a rotor and a stator. The stator may be mounted within motor housing 102 such that the stator is fixed relative to motor housing 102, and the rotor may be coupled to mixer shaft 109 via drivetrain 110. A current through windings within the stator may generate a magnetic field that induces rotation of the rotor, e.g., due to magnets or a magnetic field via coils on the stator. The rotor may rotate at a relatively high rotational velocity and relatively low torque. Thus, drivetrain 110 may be configured to provide a rotational speed reduction and mechanical advantage between motor 112 and mixer shaft 109 and/or power take off 150.

In general, a power take off attachment 180 may be mechanically coupled to power take off 150. power take off attachment 180 may be any suitable power take off attachment for processing food items, such as a grain mill, a sausage stuffer, a cheese shredder, a pasta extruder, etc. As such, food processing operations, as will described hereinbelow, may include one or more of grinding, shredding, and extruding food contents. In particular, power take off attachment 180 may be any suitable power take off attachment that includes a hopper 182 for holding food items for processing, such as a funnel or a container that directs food items through power take off attachment 180. In other words, power take off attachment 180 may include hopper 182 such that when performing food processing operations of food contents within the power take off attachment, the food contents within hopper 182 may be processed.

Stand mixer 100 may include a controller 120 provided within casing 101. In detail, controller 120 may be located within motor housing 102 of casing 101. For instance, controller 120 may be a microcontroller, as would be understood, including one or more processing devices, memory devices, or controllers. Controller 120 may include a plurality of electrical components configured to permit operation of stand mixer 100 and various components therein (e.g., motor 112). For instance, controller 120 may be a printable circuit board (PCB), as would be well known.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of stand mixer 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. According to still other example embodiments, a user interface 142 may include one or more microprocessors and/or one or more memory devices. Accordingly, certain components of stand mixer 100 may be controlled directly from user interface 142.

The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to a remote user interface (not shown) through any suitable network(s), such as through a high bandwidth local area network (LAN) or wide area network (WAN). In this regard, for example, controller 120 may further include a communication module or interface that may be used to communicate with one or more other component(s) of stand mixer 100, controller 120, an external appliance controller, an external device, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Controller 120 may be in communication with various sensors in order to measure various parameters, such as a scale 122 where the value of the parameter includes a weight of food contents. In the present example embodiment, shown in FIG. 1, the various sensors may include scale 122. Controller 120 may receive signal(s) from scale 122 corresponding to a weight measurement, e.g., of the power take off 180 and food contents therein. Scale 122 as shown may be an integrated scale within base 104 and is provided for example purposes only.

In some example embodiments, controller 120 may be configured to measure a value of a parameter of food contents in the stand mixer 100, such as a weight value from scale 122. In general, the value of the parameter of food contents in stand mixer 100 may be measured by one or both of a user input and a sensor measurement, e.g., a user may input an initial value for the weight of the food contents on user interface 142 of stand mixer 100, or scale 122 may measure the initial value for the weight of the food contents. In general, controller 120 may be configured to reacquire the value of the parameter continuously, or repeatedly, throughout the operation of the stand mixer 100. When the parameter, e.g., the weight value, is measured by scale 122 and received at controller 120, controller 120 may be configured to pause motor 112, as will be further explained hereinbelow.

The mixing process may be generally initiated by a user by either manually actuating a user input device, such as pressing a switch or turning a dial, etc., on user interface 142, or using an external device, such as a smartphone, wirelessly connected to controller 120 in the stand mixer 100, as will be described below. For example, the switch (not shown) on user interface 142 may be an electromagnetic switch or servo switch. In some example embodiments, controller 120 may include sensors configured to monitor, or take into consideration, ingredient temperature, mixer temperature, and/or altitude. As generally described above, controller 120 may be configured to operate motor 112 to provide rotational power to power take off 150 and thus to a power take off attachment 180, and measure the parameter of the food contents, e.g., the weight the food contents, within power take off attachment 180.

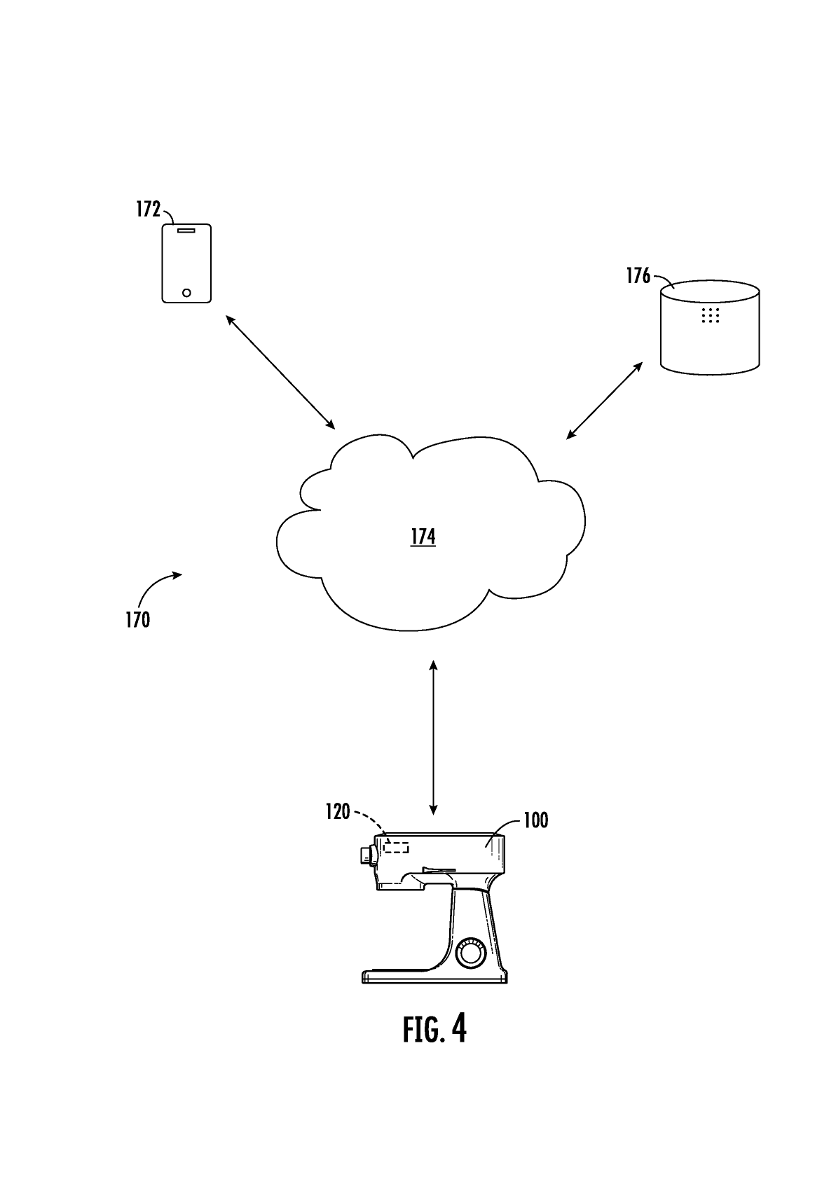

Turning ahead to FIG. 4, controller 120 may be in wireless communication with an external device, such as one or more of a smartphone 172, referred to generally as external device 172, and/or a database 176, over a network 174. In particular, FIG. 4 illustrates a schematic diagram of an external communication system 170 which will be described according to an example embodiment of the present subject matter. In general, external communication system 170 is configured for permitting interaction, data transfer, and other communications between stand mixer 100 and one or more external devices. For example, this communication may be used to provide and receive parameters, user instructions or notifications, performance characteristics, user preferences, or any other suitable information for improved performance of stand mixer 100. In addition, it should be appreciated that external communication system 170 may be used to transfer data or other information to improve performance of one or more external devices or appliances and/or improve user interaction with such devices.

For example, external communication system 170 permits controller 120 of stand mixer 100 to communicate with a separate device external to stand mixer 100, such as external device 172 and/or database 176. These communications may be facilitated using a wired or wireless connection, such as via network 174. In general, external device 172 may be any suitable device separate from stand mixer 100 that is configured to provide and/or receive communications, information, data, or commands from a user. In this regard, external device 172 may be, for example, a personal phone, a smartphone, a tablet, a laptop or personal computer, a wearable device, or another mobile or remote device.

In addition, a remote server, or database 176 may be in communication with stand mixer 100 and/or external device 172 through network 174. In this regard, for example, database 176 may be a cloud-based server, and is thus located at a distant location, such as in a separate state, country, etc. According to an example embodiment, external device 172 may communicate with database 176 over network 174, such as the Internet, to transmit/receive data or information, provide user inputs, receive user notifications or instructions, interact with or control stand mixer 100, etc. In addition, external device 172 and database 176 may communicate with stand mixer 100 to communicate similar information.

In general, communication between stand mixer 100, external device 172, database 176, and/or other user devices or appliances may be carried using any type of wired or wireless connection and using any suitable type of communication network, non-limiting examples of which are provided below. For example, external device 172 may be in direct or indirect communication with stand mixer 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an example embodiment of the present subject matter. However, it should be appreciated that the example functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

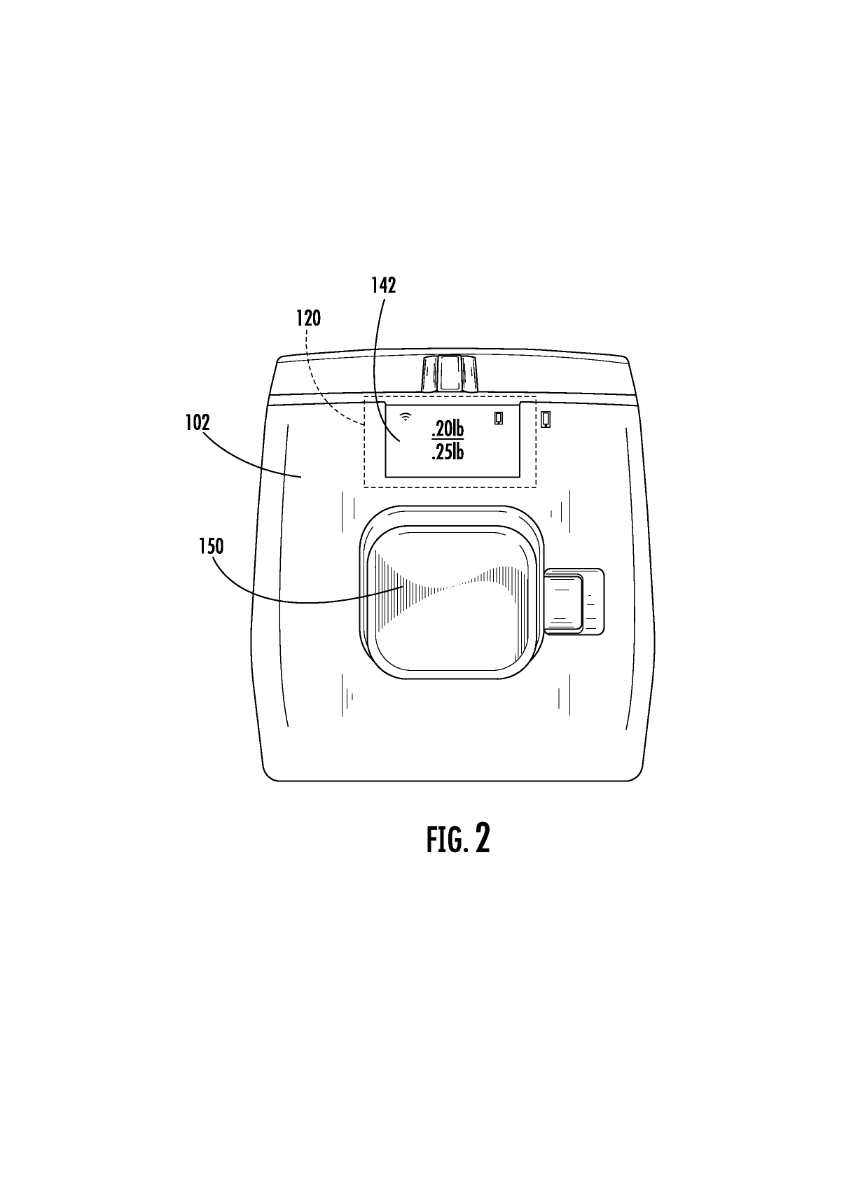

In some example embodiments, controller 120 may be further configured to record, such as in the memory devices of controller 120 or the external device, a desired value of the parameter (e.g., the weight of food contents). In some example embodiments, the desired value of the parameter may be based on a user input. Turning back again to FIG. 2, stand mixer 100 may include a display on user interface 142, such as a digital or analog display device generally configured to provide visual feedback regarding the operation of stand mixer 100. For example, the display may include one or more status lights, screens, or visible indicators. According to example embodiments, the display on user interface 142 may include one or more of a touchscreen interface, a capacitive touch panel, a liquid crystal display (LCD), a plasma display panel (PDP), or other informational or interactive displays. In particular, the display on user interface 142 may show the desired value of the parameter as well as an instantaneous (monitored) value of the parameter.

For example, in embodiments where the power take off attachment 180 is a meat grinder, the desired value of the parameter may be input on user interface 142 or through an external device to be a quarter of one pound (0.25 lbs.) of meat ground by the meat grinder. In particular, controller 120 may be configured to monitor and determine a mathematical difference between the current (monitored/instantaneous) value of the parameter to the initial value of the parameter throughout the mixing process until the desired value (e.g., or a multiple of the desired value, as explained below) of the parameter is achieved. In this scenario, the determination of the mathematical difference may allow for decisions, specifically, stand mixer 100 may pause the mixing operation when the mathematical difference of the current value of the parameter and the initial value of the parameter equal the desired value (e.g., or a multiple of the desired value) of the parameter.

As one skilled in the art will appreciate, the above described embodiments are used only for the purpose of explanation. Modifications and variations may be applied, other configurations may be used, and the resulting configurations may remain within the scope of the invention. For example, stand mixer 100 and the accompanying graphical representations of data measurements are provided by way of example only and aspects of the present subject matter may be incorporated into any other suitable stand mixer appliance.

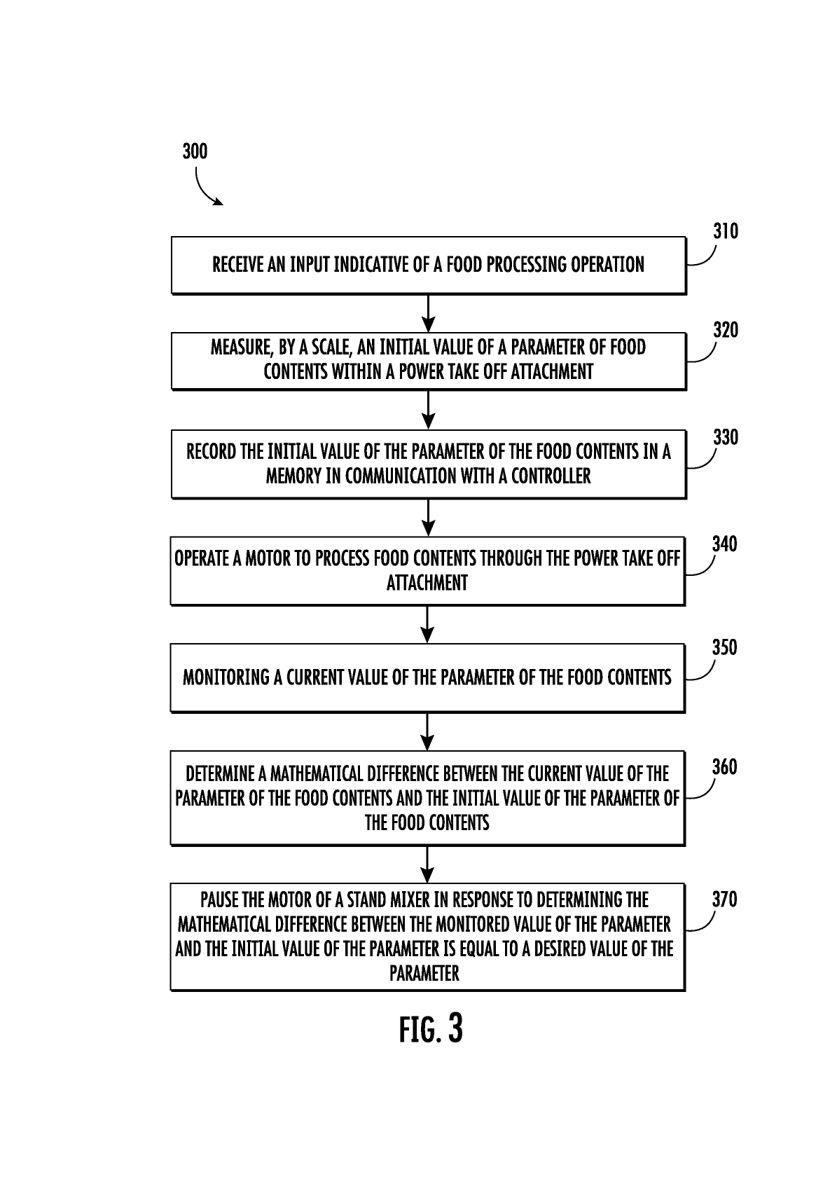

Referring now to FIG. 3, a flow diagram of one embodiment of a method 300 of operating stand mixer 100 is illustrated in accordance with aspects of the present subject matter. In general, method 300 will be described herein with reference to the embodiments of stand mixer 100 and related elements described above with reference to FIGS. 1-2 and 4. However, it should be appreciated by those of ordinary skill in the art that the disclosed method 300 may generally be utilized in association with apparatuses and systems having any other suitable configuration. In addition, although FIG. 3 depicts steps performed in a particular order for purposes of illustration and discussion, the method discussed herein is not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 3, at (310), method 300 may generally include receiving an input indicative of a food processing operation, such as a food processing operation of food contents within the power take off attachment. In general, receiving the input may include receiving a user input, such as on user interface 142 or through an external device, indicative of a food processing operation. In particular, the food processing operation may include operating power take off attachment 180 to process food contents within hopper 182 of power take off attachment 180. In one example scenario, the food processing operation may include grinding meat, such as beef, through a meat grinder power take off attachment, whereby the food processing operation includes grinding the meat from the hopper through the meat grinder power take off attachment.

Furthermore, the food processing operation may define a desired value of a parameter. As described above, in embodiments where the power take off attachment 180 is a meat grinder, the desired value of the parameter may be input on user interface 142, or through an external device, to be a quarter of one pound (0.25 lbs.) of meat grinded by the meat grinder. For example, the food processing operation may process food contents in intervals of the desired value of the parameter, as will be explained further hereinbelow. Moreover, method 300 may include zeroing the scale in response to receiving the input indicative of a food processing operation. In particular, controller 120 may zero scale 122 in response to, e.g., immediately or right after, receiving the input indicative of a food processing operation.

At (320), method 300 may generally include measuring an initial value of the parameter of food contents within the power take off attachment, such as by scale 122. For example, scale 122 may be zeroed in response to receiving the input indicative of the food processing operation, such that any food contents added to stand mixer 100 may be measured. In particular, after scale 122 is zeroed, a user may add food contents to the power take off attachment 180, whereby an initial value, e.g., the weight, of the food contents may be measured by controller 120. For example, the initial weight of the food contents may be measured to be two pounds (2 lbs.) of meat, and controller may be configured to grind at intervals with the desired value of quarter pound (0.25 lbs.) ground clusters of meat.

At (330), method 300 may generally include recording the initial value of the parameter of the food contents in a memory in communication with a controller. In particular, the memory devices of controller 120, as described above, may be configured to record the initial value of the parameter of the food contents. For example, the initial weight of the food contents may be measured to be two pounds (2 lbs.) of meat, whereby the memory devices of controller 120 may store/record the initial value of two pounds (2 lbs.) of meat.

At (340), method 300 may generally include operating the motor to process food contents through the power take off attachment. For example, to process food contents from hopper 182 of power take off attachment 180, motor 112 may operate power take off attachment 180 at a first speed, such as at a “high” speed. In general, motor 112 may be able to operate at various speeds, ranging from a “low” speed to a “high” speed, where the “low” speed is slower than the “high” speed. In particular, operating motor 112 at the first speed may include a user input or a setting of the food processing operation indicative of a desired speed of motor 112. As such, in the present example scenario, the food processing operation may include grinding meat through a meat grinding power take off attachment at the “high” speed in order to grind the meat in hopper 182.

At (350), method 300 may generally include monitoring the value of the parameter of the food contents, such as by controller 120. For example, monitoring the value of the parameter of the food contents may include continuously (e.g., repeatedly) monitoring the parameter of the food contents while operating the motor. In other words, monitoring the value of the parameter may include comparing (continuously) the monitored value of the parameter to the initial value of the parameter. In the present example scenario, the food processing operation may include the initial weight of the meat at two pounds (2 lbs.) and the desired value of the meat at a quarter pound (0.25 lbs.), and monitoring the value includes comparing the weight of the meat in hopper 182 to the initial weight. Such as a value of one and three quarter pound (1.75 lbs.) of meat in hopper 182 compared to the initial weight of the meat of two pounds (2 lbs.), which yields the desired value of the meat at a quarter pound (0.25 lbs.), i.e., a quarter pound (0.25 lbs.) of meat has been ground through meat grinder power take off attachment 180.

At (360), method 300 may generally include determining a mathematical difference between the current value of the parameter of the food contents and the initial value of the parameter of the food contents. For example, as described above, a value of one and three quarter pound (1.75 lbs.) of meat in hopper 182 may be compared to the initial weight of the meat of two pounds (2 lbs.), which, subtracting the current value of the parameter of the food contents, e.g., one and three quarter pound (1.75 lbs.), from the initial value of the parameter of the food contents, e.g., two pounds (2 lbs.), the mathematical difference may be determined to be a quarter pound (0.25 lbs.), i.e., a quarter pound (0.25 lbs.) of meat has been ground through meat grinder power take off attachment 180.

At (370), method 300 may generally include pausing the motor of the stand mixer in response to determining the mathematical difference between the monitored value of the parameter and the initial value of the parameter is equal to a desired value of the parameter. As described above, a value of one and three quarter pound (1.75 lbs.) of meat may be in hopper 182, which compared to the initial weight of the meat of two pounds (2 lbs.), yields the desired value of the meat at a quarter pound (0.25 lbs.), at which point the motor 112 may pause. In general, pausing motor 112 may include a specified amount of time the motor is paused. For example, the specified amount of time may be determined based on a user input or a predefined setting of the food processing operation. In the present example, the specified amount of time the motor is paused may be between about one second (1s) and about thirty seconds (30s), such as between about five seconds (5s) and about twenty five seconds (25s), such as between about ten seconds (10s) and about twenty seconds (20s). In other words, the duration of the pause may allow the user time to pick up the ground meat, set it aside, or, for example, immediately form it into patties. Motor 112 may then automatically restart grinding, repeating the operation at every multiple of the quarter pound (0.25 lbs.), i.e., the desired value, interval until the entire two pounds (2 lbs.), i.e., the initial value, of meat have been processed. In other words, a value of one and a half pounds (1.5 lbs.) compared to the initial value of two pounds (2 lbs.) yields the mathematical difference of a half of a pound (0.5 lbs.), which is a multiple of a quarter pound (0.25 lbs.). As such, the pausing of motor 112 may occur in response to the comparison of the monitored value to the initial value yielding a multiple of the desired value.

In another example embodiment, method 300 may further include providing a user notification in response to determining the mathematical difference between the monitored value of the parameter and the initial value of the parameter is equal to the desired value of the parameter (e.g., or a multiple of the desired value). As described above, motor 112 may automatically process the food contents until all of the food contents in power take off attachment 180 has been processed. Accordingly, stand mixer 100 may be configured to provide a user notification to a user indicative of the completion of the food processing operation, such as processing the entire two pounds (2 lbs.) amount of meat, as described above. As such, stand mixer 100 may be configured to provide a user notification to the external device, such as external device 172, or, in other example embodiments, may be configured to provide an audible alert to the user.

As may be seen from the above, a method of operating a stand mixer may automate the operation of a food processing attachment. The stand mixer may include an attachment that grinds meat using an integrated scale to automate the process of making grinding meat to homogeneous weighted clusters. A user may use the stand mixer or an external device to initialize the scale (zero it), measure the initial meat weight by placing it in the hopper, and selecting the desired weight. As the food processing attachment grinds, the ground meat may fall into a bowl or tray. The stand mixer may monitor the amount of meat that has been grinded by comparing the amount of meat in the hopper with the initial weight. The motor may be paused when it reaches the desired weight, which may allow a user to handle the ground meat before the mixer resumes grinding, until the contents in hopper 182 are finished. User notifications may also be provided for low food contents in the hopper or may be provided after processing the entire contents of the hopper.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a stand mixer, the stand mixer comprising a housing, a motor disposed in the housing, a scale, a power take off extending from the housing, a power take off attachment mechanically coupled to the power take off, and a controller disposed in the housing, the controller in operable communication with the scale and the motor, the method comprising:
receiving, by the controller, an input indicative of a food processing operation, the food processing operation defining a desired value of a parameter of food contents;
measuring, by the scale, an initial value of the parameter of the food contents within the power take off attachment;
recording the initial value of the parameter of the food contents in a memory in communication with the controller;
operating the motor to process the food contents through the power take off attachment;
monitoring, by the controller, a current value of the parameter of the food contents;
determining a mathematical difference between the current value of the parameter of the food contents and the initial value of the parameter of the food contents; and
pausing, by the controller, the motor of the stand mixer in response to determining the mathematical difference between the monitored value of the parameter and the initial value of the parameter is equal to the desired value of the parameter.

2. The method of claim 1, wherein the food processing operation comprises one or more of grinding, shredding, and extruding food contents.

3. The method of claim 1, further comprising zeroing the scale in response to receiving the input indicative of the food processing operation.

4. The method of claim 1, wherein the parameter comprises a weight of the food contents within the power take off attachment.

5. The method of claim 1, wherein monitoring the current value of the parameter comprises continuously monitoring the parameter while operating the motor.

6. The method of claim 1, wherein pausing the motor comprises a specified amount of time the motor is paused.

7. The method of claim 6, wherein the specified amount of time is determined based on a user input or a predefined setting of the food processing operation.

8. The method of claim 1, further comprising providing, by the controller, a user notification in response to determining the mathematical difference between the monitored value of the parameter and the initial value of the parameter is equal to the desired value of the parameter.

9. The method of claim 1, wherein the power take off attachment comprises a hopper, wherein operating the motor to process food contents within the power take off attachment comprises processing food contents from the hopper.

10. A stand mixer, comprising:
a housing; a motor disposed in the housing;
a scale;
a power take off extending from the housing;
a power take off attachment mechanically coupled to the power take off; and
a controller disposed in the housing, the controller configured to:
receive an input indicative of a food processing operation, the food processing operation defining a desired value of a parameter of food contents;
measure, by the scale, an initial value of the parameter of the food contents within the power take off attachment;
record the initial value of the parameter of the food contents in a memory in communication with the controller;
operate the motor to process food contents through the power take off attachment;
monitor a current value of the parameter of the food contents;
determine a mathematical difference between the current value of the parameter of the food contents and the initial value of the parameter of the food contents; and
pause the motor of the stand mixer in response to determining the mathematical difference between the monitored value of the parameter and the initial value of the parameter is equal to the desired value of the parameter.

11. The stand mixer of claim 10, wherein the food processing operation comprises one or more of grinding, shredding, and extruding food contents.

12. The stand mixer of claim 10, wherein the controller is further configured to zero the scale in response to receiving the input indicative of the food processing operation.

13. The stand mixer of claim 10, wherein the parameter comprises a weight of the food contents within the power take off attachment.

14. The stand mixer of claim 10, wherein monitoring the current value of the parameter comprises continuously monitoring the parameter while operating the motor.

15. The stand mixer of claim 10, wherein pausing the motor comprises a specified amount of time the motor is paused.

16. The stand mixer of claim 15, wherein the specified amount of time is determined based on a user input or a predefined setting of the food processing operation.

17. The stand mixer of claim 10, wherein the controller is further configured to provide a user notification in response to determining the mathematical difference between the monitored value of the parameter and the initial value of the parameter is equal to the desired value of the parameter.

18. The stand mixer of claim 10, wherein the power take off attachment comprises a hopper, wherein operating the motor to process food contents within the power take off attachment comprises processing food contents from the hopper.
